(19) United States
(12) Patent Application Publication
(10) Pub. No.: US 2011/0284542 A1
(43) Pub. Date: Nov. 24, 2011

(54) Fuel cap cover

(76) Inventor: Darrell Mackay, Oregon City, OR (US)

(21) Appl. No.: 12/783,418

(22) Filed: May 19, 2010

(51) Int. Cl. B60K 15/035; B21D 53/88; B65D 51/16

(52) U.S. Cl. 220/303; 220/367.1; 220/203.21; 29/897.2

(57) ABSTRACT

A cover for a vented fuel tank cap comprises a cover body in which a cavity and a vent are formed. The vent may be built into the cap by drilling at an acute angle through a lower surface and an interior sidewall, and into the ceiling of the cavity. A hollow member extends from the ceiling into the cavity, allowing the cavity to remain in fluid communication with the vent. The exterior surface of the structure forms a barb for securing a flexible tube. The position of a moveable element within the cylinder, such as a ball, acts as a valve allowing air to enter the fuel tank through a slot when the cover is in place, while preventing loss of fuel if the tank assembly becomes inverted. The fuel cap cover features a low exterior profile, without protrusions, and the cover preferably has no articulated or detachable parts.

### TECHNICAL FIELD

This invention relates to an apparatus for motorcycles, all-terrain vehicles, and the like, that provides a fuel tank vent suitable for off-road use on rugged, uneven terrain.

### BACKGROUND INFORMATION

It is common for off-road motorcycles and all-terrain vehicles (ATVs) to rely on gravity to supply fuel to their engines, rather than employing a fuel pump. In such a configuration, liquid fuel stored in a fuel tank drains out through a fuel line attached to the bottom of the tank when air is permitted to enter the tank from above so that air pressure above the liquid fuel forces the fuel downward into the fuel line. If a sufficient volume of air is unable to enter the tank, vapor lock may occur, in which gasoline vapor blocks the flow of fuel into the fuel line, potentially causing the engine to stall. Motorcycle and ATV manufacturers typically prevent this problem from occurring by using a specialized gas cap equipped with a nipple that protrudes upward from the top surface of the cap and, attached to the nipple, a hose that provides a pathway for air to enter the tank. Such an apparatus ensures a supply of air to the tank. However, when the vehicle is ridden off-road, over rough, undulating ground, or if the vehicle tilts or rolls over, fuel may spill out through the opening in the cap and through the inverted hose. Some manufacturers address this problem by providing a one-way ball valve inserted into the hose. Although such a valve prevents fuel from spilling most of the time, the protruding hose, containing the valve, may become dislodged and may even fall out during a rough ride. If the hose and the one-way valve are lost, a significant amount of fuel may be splashed onto the rider.

Such inadequacies in preventing fuel loss have been acknowledged and addressed in U.S. Pat. No. 4,913,303, directed to a “splash control” fuel cap containing a central ball-and-spring float valve assembly and a controllable pressure relief vent. U.S. patent application Ser. No. 11/561,318 also describes a vented cap for fuel tanks, the cap having, on opposite sides, a pair of inverted venting channels that are protected from clogging, and in the center, a tilt-dependent ball valve assembly. Such inverted vents channel outside air through at least two successive 90 degree bends prior to the air entering the tank. Both of these solutions are essentially versions of “after-market” threaded fuel caps, designed to replace the standard threaded cap provided by the fuel tank manufacturer to seal the filler neck of the fuel tank. As such, these prior art caps must either fit a single, standard size threaded neck, or they must be customized to fit multiple non-standard fuel tank models from each of many different manufacturers. In addition, each of these caps, as disclosed, contains many distinct, detachable parts, including diaphragms, gaskets, and machined surfaces having threads, beads, flanges, grooves, openings, teeth, notches, and the like.

### SUMMARY

The present disclosure describes a self-contained cover that universally attaches to, or fits over, a standard existing vented fuel tank cap. The exterior form of the cover features a low profile, without surfaces that could allow the cover to become accidentally dislodged from the cap. Unlike conventional vented caps, the fuel cap cover disclosed herein maintains a low profile because it houses a one-way ball valve chamber inside the cover and therefore no part of the device protrudes above the top surface of the cover. Furthermore, the vent is built into the walls of the cap, and because the overall cover is self-contained, it requires no articulated or detachable parts that could loosen and fall out of the apparatus. Inventive elements of the cover may also be directly built into a fuel tank cap to achieve the same advantages as the cover.

The fuel cap cover of the present disclosure comprises a cover body, preferably made of metal, in which a cavity and a vent are formed. In a preferred embodiment, the cover body is a solid body, the cavity is radial and the vent is directed at an acute angle with respect to a central axis of the cover body. The vent may be made by drilling through a lower surface of the cover body, through a thick interior sidewall of the cavity, and into a thick interior ceiling of the cavity. A hollow member protrudes from the interior ceiling into the cavity, so that the space within the hollow member remains in fluid communication with the vent, allowing air to enter the fuel tank when the cover is in place. Air moving through the vent follows a path having a single turn that is preferably less than 90 degrees. An outer surface of the hollow member is flanged to form a barb for securing a flexible tube. A moveable element, such as a plastic ball, is contained at all times within the protruding hollow member. Furthermore, a slot is cut across the lower surface of the hollow member so that when a tube is secured by the barb, a stable position of the ball with respect to the slot forms a valve that allows air to enter the fuel tank, while the ball resists motion of liquid fuel splashing upward from within the tank. If the tank should become inverted, the ball's position shifts to cover the vent and prevent liquid fuel from escaping through the cap.

It is to be understood that this summary is provided as a means for generally determining what follows in the drawings and detailed description, and is not intended to limit the scope of the invention. Objects, features and advantages of the invention will be readily understood upon consideration of the following detailed description taken in conjunction with the accompanying drawings.

### BRIEF DESCRIPTION OF THE DRAWINGS

FIG. 1 is a perspective view of a top side of a frustum-shaped gas cap cover.

FIG. 2 is a perspective view of a top side of a polyhedral-shaped gas cap cover.

FIG. 3 is a perspective view as seen from the base, or underneath side, of the frustum-shaped gas cap cover shown in FIG. 1, showing a vent and a barbed hollow member comprising a ball valve.

FIG. 4 is a schematic cross-section of the inverted frustum-shaped gas cap cover shown in FIGS. 1 and 3, taken along lines 3-3 in FIG. 3, to show its interior structure and that of the ball valve and the vent.

FIG. 5 is a schematic cross-section of a gas cap that incorporates unique features of the gas cap cover shown in FIGS. 1, 3 and 4.

### DETAILED DESCRIPTION OF ILLUSTRATIVE EMBODIMENTS

In the following description many details are set forth to provide an understanding of the disclosed embodiments of the invention. However, upon reviewing this disclosure, it will become apparent to one skilled in the art that not all of the disclosed details may be required to practice the claimed invention and that alternative embodiments might be constructed without departing from the principles of the invention.

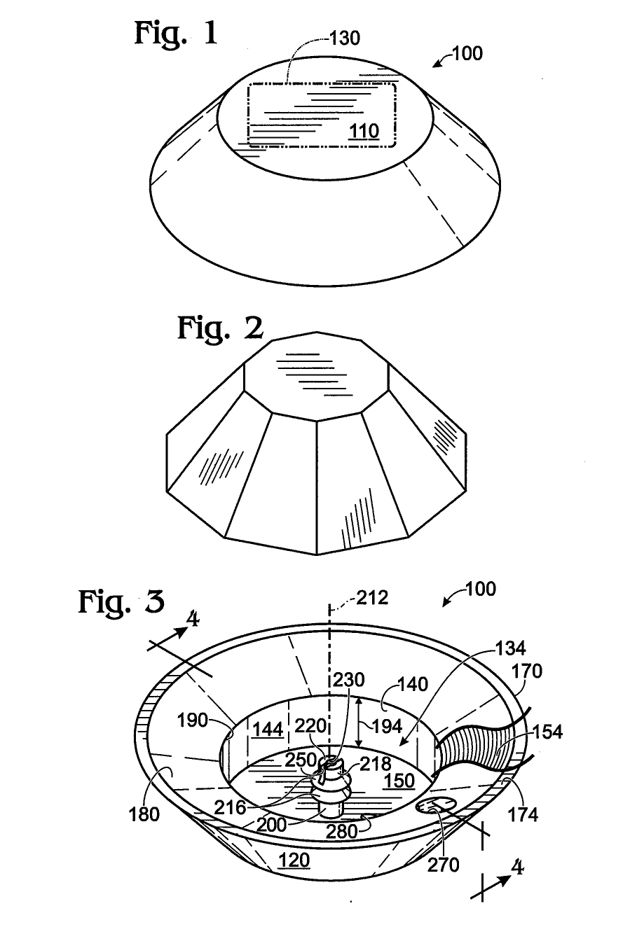

FIG. 1 shows a preferred embodiment of a gas cap cover 100. Cover 100 comprises a cover body 110, preferably made of a solid metal such as aluminum, and preferably having a polished or anodized exterior surface 120 that may be further decorated by etching, embossing, or attaching a graphic motif 130. Graphic motif 130 may include, for example, a logo, an emblem, a monogram, an alphanumeric printed message, or a representational or abstract artistic image. Cover body 110 preferably has the shape of a frustrum (i.e., a truncated cone), a hemisphere, or half of an n-sided geometric solid such as a tetrahedron, a dodecahedron, or other polyhedron, as indicated in FIG. 2

FIG. 3 shows a view from the underneath side of gas cap cover 100. The cover may be cast, machined, extruded, molded, or otherwise formed to include a cavity 134, preferably radially symmetric, in the interior of cover body 110. Cavity 134 defines an interior surface 140 of a sidewall 144, and an interior ceiling 150. Surface 140 is preferably straight and vertical as shown, though in general, sidewall 140 may be curved or angled. Interior sidewall 140 is preferably substantially smooth, without threads, though it may be otherwise textured. Interior ceiling 150 is preferably flat and horizontal as shown, though in general, ceiling 150 may be partly or fully domed or angled and may have a rough or patterned surface. Precision machining on a lathe or other cutting device may be indicated by optional textured artifacts such as circular grooves 154 remaining on one or more surfaces of cavity 134 and cover body 110. The distance between interior surface 140 and exterior surface 120 defines a sidewall thickness of sidewall 144. According to a preferred embodiment, a peripheral edge 170 of cover body 110 preferably has a flat bevel 174, and a lower surface 180 of sidewall 144 is preferably angled radially inward such that, in the upright orientation shown in FIG. 1, gas cap cover 100 rests on the peripheral flat bevel 174. In addition, a preferred embodiment as shown in FIG. 3 has an inner, optionally beveled edge 190, at which the lower surface 180 of sidewall 144 meets interior surface 140. The distance between ceiling 150 and inner edge 190 defines a sidewall height 194.

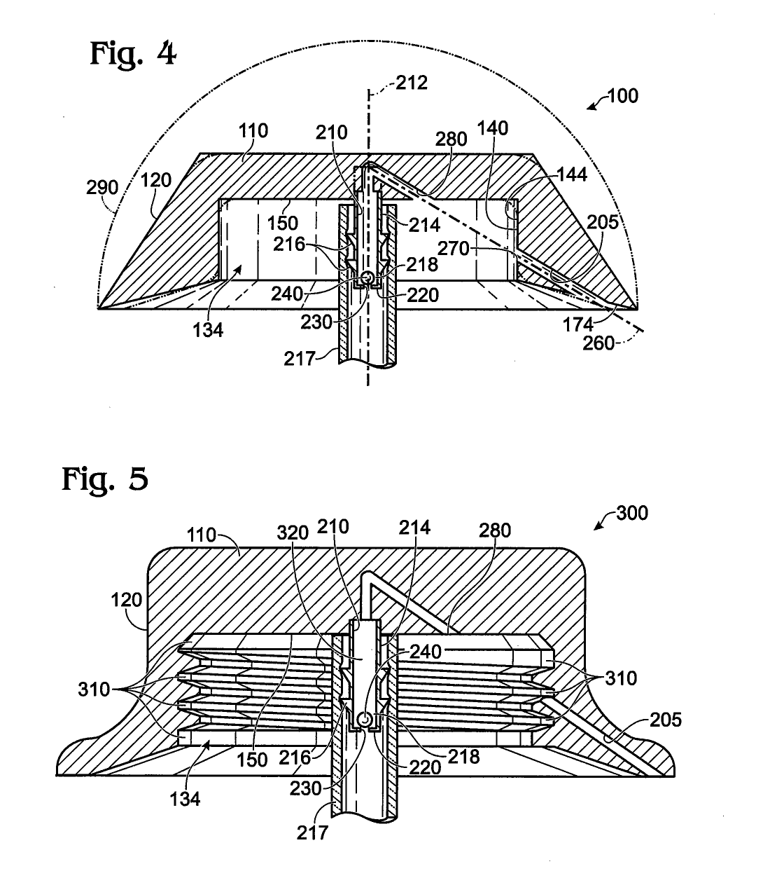

Two important functional features of gas cap cover 100 are shown in each of FIGS. 3 and 4—a ball valve comprising a barbed hollow member 200, and a vent 205. Member 200 may be fashioned as a separate piece that may be joined with cover body 110 after opening in ceiling 150, a ceiling aperture 210, preferably axial, into which member 200 may be inserted and secured. Axial ceiling aperture 210 is preferably substantially aligned with the center of cover body 110. A drill press or other means of force for establishing durable attachment may be employed to fuse member 200 with cover body 110, achieving a friction fit without a need to rely on additional hardware. To enhance the strength of the attachment, an adhesive may also be applied to adjacent surfaces of member 200 and cover body 110 such as, for example, Loctite™ or, if member 200 and cover body 100 are both metallic, a similar bonding agent for joining two metal components, in which the bonding formula may vary depending on the two metal compositions.

Barbed member 200, extending along a central axis 212 from interior ceiling 150 into cavity 134, may be formed from the same material as cover body 110. The length of member 200 is preferably shorter than the sidewall height 194. Member 200 has a generally cylindrical shape, having a cross section that may be circular as shown in FIGS. 3 and 4, but could be, alternatively, elliptical, rectangular, or the like. Outer surface 214 of hollow member 200 is preferably machined so as to form one or more tiered flanges 216 (“barbs”) for securing a hose 217 onto member 200 and for holding the hose in place after member 200 is mated with a gas cap by either inserting member 200 into an opening in the gas cap, or by fitting sidewall 140 over some portion of the gas cap.

A distal end 218 of member 200 has a flat lower surface 220 in which an aperture 230 is formed, preferably at the center. The shape of distal end 218 may be straight, curved, beveled, or bulbous so as to hold a ball 240, which remains trapped within hollow member 200, but whose motion is otherwise unconstrained so that ball 240 may rattle freely within member 200. Ball 240 is preferably made of metal, nylon, or another material that offers resistance to degradation from volatile organic compounds found in gasoline and other petroleum products, or from corrosive substances that may be present in gasoline additives. A notch 250 extending across the middle of lower surface 220 intersects aperture 230 and is cut deeply enough along central axis 212 so as to allow air to pass through member 200 into cavity 134 when gas cap cover 100 is placed in its upright position and ball 240 is thus held in distal end 218.

Vent 205 is preferably formed directly within cover body 110 along a vent axis 260 so as to further simplify the functional design of gas cap cover 100, and to avoid introducing additional parts. Vent axis 260 and central axis 212 form an acute angle. Vent 205 may be fashioned by drilling two angled apertures in cover body 110, using a cylindrical drill bit or other similar machining tool. A first vent aperture 270 may be opened by directing the drill bit into lower surface 180, and out of sidewall 144 so that the drill bit emerges into cavity 134. A second vent aperture 280 may be opened by continuing to drill through cover body 110 along vent axis 260 into interior ceiling 150 until vent aperture 280 intersects axial ceiling aperture 210. Vent 205 thus allows an unobstructed flow of air along an acute-angled path through both vent apertures 270 and 280, through axial ceiling aperture 212, through hollow member 200, and through notch 250, into cavity 134, as long as gas cap cover 100 remains in a generally upright position. Axial ceiling aperture 210, having generally a larger diameter than vent 205, may simply intersect with vent 205, or it may narrow to the size of vent 205 prior to the point of intersection. The diameter of vent 205 is necessarily smaller than the diameter of ball 240 to allow ball 240 to seat properly at the opening of vent 205, to prevent loss of ball 240, and to ensure that, if the gas tank, cap, and cover should become inverted, the force of gravity causes ball 140 to re-position itself so as to block axial ceiling aperture 210, thus preventing fuel from flowing through vent 205. With reference to FIG. 4, optional bevels on various surfaces are shown in double-dot-dashed lines, which are also used to indicate a cover body 110 in the shape of a hemisphere 290 as an exemplary alternative to a frustum-shaped cover body.

FIG. 5 shows a gas cap 300, featuring the built-in diagonal vent 205 and ball valve configured as fixed hollow member 320, offering similar advantages described above for gas cap cover 100. A principal difference between cap 300 and cover 100 is that interior surface 140 is configured with threads 310 in the case of cap 300, for screw attachment directly to a tank. In this gas cap embodiment, distal end 218 of cap hollow member 320 need not function as an attachment device, and thus distal end 218 may assume a somewhat more passive role, because threads 310 are relied upon to hold gas cap 300 in place. Furthermore, in a gas cap embodiment, hollow member 320 provides fluid communication between vent 205 and the fuel tank, but member 320 need not have barbs and need not support a hose. However, if these optional features are retained, the embodiment, as it is shown in FIG. 5, may serve as a dual-purpose device that can function either as a vented gas cap, or as a gas cap cover.

The terms and expressions that have been employed in the foregoing specification are used therein as terms of description and not of limitation, and there is no intention, in the use of such terms and expressions, to exclude equivalents of the features shown and described or portions thereof, it being recognized that the scope of the invention is defined and limited only by the claims which follow.

1. A cover for a vented fuel tank cap, the cover comprising:
a cover body, in which a cavity and a vent are formed, the cavity defining an interior sidewall and an interior ceiling;
a hollow member having a proximal end secured within an aperture in the ceiling, a distal end extending into the cavity and including an aperture therein, and an outer surface forming a barb for supporting one end of a flexible tube having an opposite end for insertion into an aperture in the fuel tank cap, the hollow member thereby attaching the cover to the fuel tank cap, and further providing fluid communication between the vent and the fuel tank; and
a moveable element contained within the hollow member, disposed therein so as to prevent fuel loss when the moveable element is forced to the proximal end of the hollow member, while allowing air to enter the fuel tank when the moveable element is forced to the distal end of the hollow member, the moveable element thereby acting as a valve.

2. The cover of claim 1, wherein the vent comprises an aperture directed at an acute angle with respect to the hollow member, the vent extending through the sidewall, and through the ceiling to connect with the aperture in the ceiling.

3. The cover of claim 1, wherein the cover body is made from a metal such as steel, aluminum, or nickel.

4. The cover of claim 1, wherein at least a portion of the exterior of the cover body is polished, anodized, or decorated with a graphic motif.

5. The cover of claim 1, wherein the cover is self-contained, requiring no separate articulated or detachable parts.

6. The cover of claim 1, wherein the interior sidewall is substantially smooth.

7. The cover of claim 1, wherein the hollow member is formed separately, and is attached to the cover body.

8. The cover of claim 1, wherein the cover body shape is substantially a frustum.

9. The cover of claim 1, wherein the cover body shape is substantially a hemisphere.

10. The cover of claim 1, wherein the cover body shape is substantially half of a polyhedral geometric solid.

11. The cover of claim 1, wherein an edge of the cover body is beveled.

12. The cover of claim 1, wherein the moveable element is a ball.

13. A method of making a cover for a vented fuel tank cap, the method comprising:
forming a cover body having a cavity defining an interior ceiling and an interior sidewall;
opening an aperture in the ceiling of the cover body;
securing within the aperture a barbed hollow member containing a movable element;
opening a vent in the cover body to connect with the aperture, the vent having a smaller diameter than the aperture, thus providing a pathway for air to enter the cavity while the moveable element prevents loss of fuel; and
attaching a flexible tube to the barbed member.

14. The method of claim 13, wherein forming the cavity in the cover body is accomplished by casting, extruding, machining, cutting, or molding.

15. The method of claim 13, wherein securing the first end of the hollow member within the aperture is accomplished using force to achieve a friction fit.

16. The method of claim 13, wherein securing the first end of the hollow member within the aperture is accomplished using a bonding agent.

17. The method of claim 13, wherein opening the aperture and the vent are accomplished by drilling.

18. A fuel tank cap, comprising:
a cap body, in which a cavity and a vent are formed, the cavity defining an interior ceiling and an interior sidewall, the sidewall configured to attach the cap to a fuel tank;
a hollow member having a proximal end secured within an aperture in the ceiling, and a distal end extending into the cavity and including an aperture therein, the hollow member providing fluid communication between the vent and the fuel tank; and
a moveable element contained within the hollow member, and disposed therein so as to prevent fuel loss when the moveable element is forced to the proximal end of the hollow member, while allowing air to enter the fuel tank when the moveable element is forced to the distal end of the hollow member, the moveable element thereby acting as a valve.

19. The cap of claim 18, wherein the cover body shape is a hemisphere, a frustum, or substantially half of a polyhedral geometric solid.

20. The cap of claim 18, wherein an exterior surface of the cap is polished, anodized, or decorated with a graphic motif.

21. The cap of claim 18, wherein the cap is self-contained, requiring no separate articulated or detachable parts.

22. The cap of claim 18, wherein the sidewall is provided with threads to attach the cap to a fuel tank.

23. A method of making a fuel tank cap, the method comprising:
forming a cap having a cavity defining an interior ceiling and an interior sidewall;
opening an aperture in the ceiling of the cap;
securing within the aperture an end of a hollow member containing a movable element;
opening a vent in the cap to connect with the aperture, the vent having a smaller diameter than the aperture; and
configuring the sidewall for attachment to a fuel tank.

24. The method of claim 23, wherein forming the cavity in the cap is accomplished by casting, extruding, machining, cutting, or molding.

25. The method of claim 23, wherein securing the end of the hollow member within the aperture is accomplished using force to achieve a friction fit.

26. The method of claim 23, wherein securing the end of the hollow member within the aperture is accomplished using a bonding agent.

27. The method of claim 23, wherein opening the aperture and the vent are accomplished by drilling.

28. A method of venting a fuel tank, having a fuel inlet, the method comprising:
providing a body having a hollow member, the hollow member extending away from the body and containing a moveable element that acts as a valve, in which body is formed a continuous channel in fluid communication at one end with the hollow member; and
attaching the body over the fuel inlet of the fuel tank so as to prevent fuel loss when the moveable element is forced to the proximal end of the hollow member, while allowing air to enter the fuel tank when the moveable element is forced to the distal end of the hollow member, and covering at least a portion of the fuel inlet.

29. The method of claim 28, wherein the body covers at least a portion of a fuel tank cap attached to the fuel inlet.

30. The method of claim 29, further comprising placing a hose over a distal end of the hollow member for securing the hollow member to a fuel tank cap.

31. The method of claim 28, wherein the body is attached directly to the fuel inlet.
